(19) United States
(12) Patent Application Publication
(10) Pub. No.: US 2011/0095045 A1
(43) Pub. Date: Apr. 28, 2011

(54) BODY FILLER DISPENSER

(76) Inventors: James H. Speck, Campbellville (CA); Jacob Niemans, (US); Bart Gravendeel, (US)

(21) Appl. No.: 12/848,491

(22) Filed: Aug. 2, 2010

Related U.S. Application Data
(60) Provisional application No. 61/230,404, filed on Jul. 31, 2009.

(51) Int. Cl. B67D 7/06

(52) U.S. Cl. 222/1; 222/386; 222/81

(57) ABSTRACT

A combination of a body filler and a container for dispensing the body filler, including a filler having a density adapted for containment in the container. The filler includes at least a thermoplastic microsphere and a polyester resin. A container stores and dispenses the filler. The container includes a closable opening, a cylindrical wall, a closure for selective closing the opening, and a plug axially movable within the cylindrical wall of the container. The container plug pushes against a volume of the filler to urge the filler through and opening of the container.

### CLAIM OF PRIORITY

This application claims priority to U.S. Provisional Patent Application No. 61/230,404 filed Jul. 31, 2009, entitled “Body Filler Dispenser” by James H. Speck et al., the disclosure of which is hereby incorporated by reference in its entirety.

### INCORPORATION BY REFERENCE

International Publication No. WO 2008/136662 published on Nov. 13, 2008, is hereby incorporated by reference.

### BACKGROUND OF THE DISCLOSURE

The present disclosure relates to a container for storing a viscous liquid or semi-solid material such as a body filler, putty or flow putty filler. The present disclosure is directed to a body filler, putty and flow putty filler (all of which are referred to herein as “body fillers”) used in the automotive refinish, marine and industrial markets. The body filler may be used for repairing of surface dents, scratches and imperfections from the bare substrate to the topcoat, leaving a seamless repair. Body fillers have been in existence for many years but have often been manufactured using glass microsphere technology. While this disclosure contemplates the use of glass microspheres, one embodiment is directed to the use of plastic microspheres in the body filler or putty. More specifically, it relates to a container provided with a closable opening, a cylindrical wall, a closure member and a bottom. Such containers are generally known, for instance in the form of a paint can. The disclosure relates particularly to containers for storing and dispensing body filler. A problem with existing containers is that part of the body filler remains in the container when it is poured due to adhesion to the wall, the lid and the bottom. This remaining body filler can be scraped out of the container using a spatula, although this is perceived to be laborious and is therefore often dispensed with.

The disclosure addresses this problem in an easy, reliable and inexpensive manner. For this purpose the bottom of the container is formed by a disc or disc-shaped plug, and the disc is axially movable in the container such that body filler present in the container can be pressed out of the container via the opening by moving the disc toward the upper end of the container and the lid. In this way, substantially all the body filler can be pressed out of the container. The disc may have a thickness such that it can move as a piston in the container without tilting as it does so. The disc or plug can be solid or hollow. In particular, it can have a substantially tubular (e.g., frusto-conical) side wall with a plate-like upper wall on the side directed toward the lid of the container.

Thus the disclosure provides a new and improved dispenser for body filler which overcomes the above-mentioned deficiencies and others while providing better and more advantageous overall results.

### SUMMARY OF THE DISCLOSURE

In one aspect of the disclosure, a combination of a body filler and a container for dispensing the body filler are provided. The combination includes a filler having a density adapted for containment in the container. The filler includes plastic microspheres and a polyester resin. A container for storing and dispensing the filler includes a closable opening, a cylindrical wall, a closure member for selective closing the opening, and a plug axially movable within the cylindrical wall of the container. The plug is movable to expel the filler through the opening of the container.

In another aspect of the disclosure, a combination of a body filler and a container for storing and pouring the body filler are provided. Thermoplastic microspheres are included in the body filler. The container includes a movable plate that reduces a volume of a containment space defined by the container. Movement of the plate dispenses the body filler through an opening of the container.

In another aspect of the disclosure, a method of dispensing a body filler includes mixing a thermoplastic microsphere and a polyester resin to form a filler having a viscosity similar to a soft solid. The filler is contained in a container adapted to maintain a density of the filler and to dispense the filler. The method includes urging the filler through an opening formed in the container by movement of a plate or disc inside the container toward the opening. The filler is contained in the container between the opening and the plate or disc.

In one embodiment, the plug (or disc) of the container is substantially disc-shaped and has an outer diameter in a radial direction which is smaller than the inner diameter of the cylindrical wall, wherein a top surface of the disc is provided along its peripheral edge with an annular scraping element extending laterally from the peripheral edge to the inner cylindrical wall. This provides a surface which is easily movable along the cylindrical wall with minimal friction. The scraping element can be manufactured integrally with the disc, whereby the disc is simple to manufacture and reuse.

The scraping element surface is oriented obliquely or at an angle to the lid and a longitudinal axis of the cylinder, whereby the body filler is guided away from the inner cylindrical wall. This minimizes the body filler becoming trapped between the disc and the wall. The scraping element is preferably strip-like and has a sharp edge on its outer end, which provides an effective scraping. There is minimal contact between the inner wall and the plug, resulting in minimal friction. If the closure member is arranged on or in the opening after the body filler or putty has been placed in the container, the interior of the container becomes pressurized as the plug is moved.

The underside of the closure member (e.g., a lid) may be provided with a recess in which the scraping element is received such that as surfaces of the plug and the lid are moved toward each other, substantially all of the body filler or putty is pressed out of the container.

The disc may have a second scraping element extending from the peripheral edge of the disc and spaced apart from the first scraping element for the purpose of collecting residue body filler remaining from the first scraping element. The second scraping element has substantially the same conformation as the first scraping element and extends in substantially the same direction.

The peripheral edge of the plug or disc may be substantially frusto-conical. The maximum outer diameter of the plug is substantially equal to the inner diameter of the cylindrical wall. The plug only contacts the wall at several locations along the axis of the wall, resulting in minimal friction and an effective seal.

The disc peripheral edge may be positioned opposite the scraping surface, particularly in an embodiment with a smaller peripheral edge of the disc and a scraping element extending outward. In an embodiment with a disc having a frusto-conical form, and with the scraping surface opposite the peripheral edge, the area of contact between the disc and the container is minimized.

In accordance with one aspect of the disclosure, the disc is provided with external engaging means to facilitate moving the disc in the cylinder.

In accordance with another aspect of the disclosure, a closable opening is provided in the lid. The closable opening is sealed, such as with a foil. The closable opening can also have a removable cap. The lid is also provided with strengthening ribs for preventing deforming of the lid when the lid is under pressure.

In accordance with another aspect of the disclosure, the container is reusable by being cleaned and refilled. The container can be manufactured from plastic. The disc may include a plate-like upper wall oriented toward the lid of the container. An inner wall of the container may have an inward folded edge which receives a side wall of the disc. A clamping connection can be made between the disc and the container, thereby preventing or minimizing leakage of filler.

In accordance with another aspect of the disclosure, the container has a detachable outlet pipe through which body filler or putty can be discharged from the container. The outlet pipe is provided with mounting means such as releasable snap connecting means, for mounting the pipe in an opening of the container. The body filler can then be poured or otherwise discharged from the container with minimal spillage.

The outlet pipe may be provided with a pointed or tapered outer end with which the seal of the container opening can be pierced. The disc may be provided with a cavity for receiving the pointed end of the outlet pipe.

Still another aspect of the disclosure is a container which effectively dispenses body filler out of the container, thus maximizing usage of the body filler.

Another aspect of the disclosure is that the container is useful for dispensing two part resin systems in which the resin component is separately contained from a liquid hardener component which, when combined, can form a hardened solid mass within about 30 minutes. Exemplary two part resin systems are disclosed, for example, in U.S. Pat. Nos. 3,051,679; 3,873,475; 4,590,101; and 5,371,117, the disclosures of which are incorporated herein by reference. For example, the resin component may include some or all of the following: a resin, such as an unsaturated polyester, vinyl ester, or epoxy resin; one or monomers, such as styrene or other monomer with a vinyl group which permits polymerization; one or more particulate fillers, such as talc, calcium carbonate, silica, or other inorganic particulate filler; fibrous fillers; one or more rheological modifiers, such as clay; one or more pigments, such as carbon black or titanium dioxide; one or more density reducing components, such as microspheres; and sufficient solvents, plasticizers, or the like, such as a ketone or acetate solvent, to provide the resin component with a viscosity which allows it to be dispensed from the dispenser compartment as a liquid or paste. The liquid hardener component may include one or more organic peroxides or other catalysts, such as methyl ethyl ketone peroxide, 2,4-pentadione peroxide, cumyl hydroperoxide, or the like, and may additionally include one or more of the components listed above for the resin component, apart from the resin.

Other aspects of the disclosure will become apparent upon a reading and understanding of the following detailed description.

### BRIEF DESCRIPTION OF THE DRAWINGS

The disclosure will be further illustrated on the basis of an exemplary embodiment shown in the figures, in which:

FIG. 1 shows a perspective view of a container according to the disclosure;

FIG. 2 shows an exploded perspective view of the container of FIG. 1;

FIG. 3 shows a container with a container outlet pipe according to another aspect of the disclosure;

FIG. 4 shows a cross-section of a closure member with the outlet pipe of FIG. 3 inserted therein;

FIG. 5 shows a perspective view in partial cross-section of the disc of FIG. 3;

FIGS. 6 and 7 show a perspective cross-section of the system of FIG. 3 of the disc traveling toward the lid;

FIG. 8 shows a cross-section of the system of FIG. 3; and

FIG. 9 shows a flow-chart illustrating a method of utilizing the container of the present disclosure.

### DETAILED DESCRIPTION OF THE DISCLOSURE

In the present disclosure, a container is designed for assisting a flow of a viscous liquid. In an exemplary embodiment of the disclosure, this liquid is a body filler or, more specifically, a body filler in putty form. However, there is no limitation made herein to the liquid contents and to a viscosity of the contents. For example, the body filler can alternatively deviate from putty form and take a form as a spray having much less viscosity. For example, the body filler may have a viscosity of at least 500 or 1,000 mPa s (Millipascal second) at a temperature of 25° C., and in one embodiment a viscosity of at least 50,000 or 100,000 mPa s at 25° C.

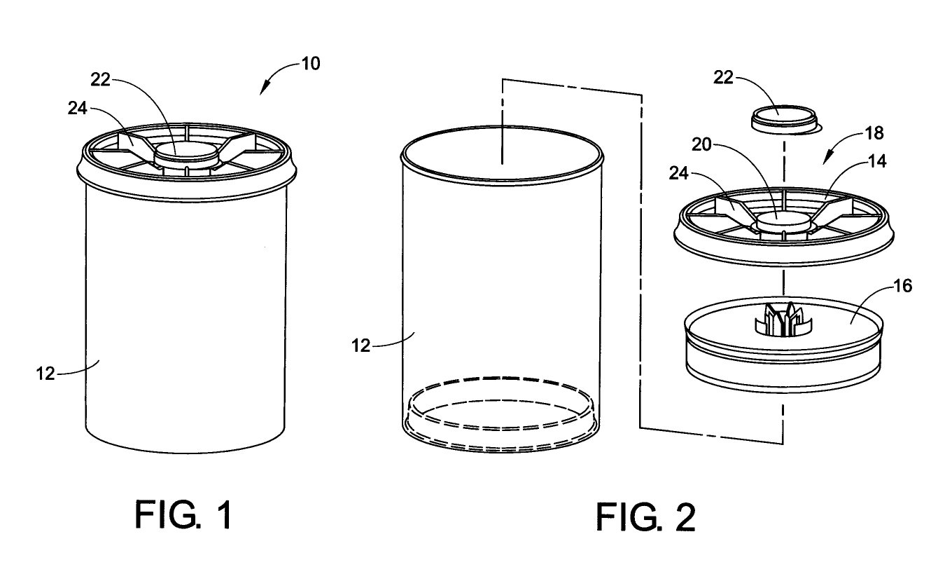

The terms, “top,” “bottom” and the like refer to the orientation of components such as shown in the FIGS., bearing in mind that the container is generally inverted during use. Referring now to FIGS. 1 and 2, a container 10 to be used for storing and dispensing body fillers, such as those discussed above, is shown. The container 10 can be manufactured of a thermoplastic material for storing and pouring or dispensing body fillers. The container includes a cylindrical wall 12 with first and second open ends, a closure member, such as a removable lid 14, which closes the first open end of the container, and a plug (or disc) 16, which is slidable within and along cylindrical wall 12 from adjacent a second open end of the container. The plug 16 is manually slid or pushed toward the underside of the lid 14. The disclosure also contemplates use of a mechanical device to move the plug. Lid 14 has a central pouring opening 18 which can be provided with a seal 20, such as aluminum foil, and which may be further closed by a reclosable cap 22. Lid 14 with cap 22 can also be removed wholly from cylindrical wall 14 and reclosed so that the container 14 can easily be cleaned and reused. Lid 14 can be provided on an external side with radially extending strengthening ribs 24 in order to prevent bulging or deforming of the lid when pressure is exerted.

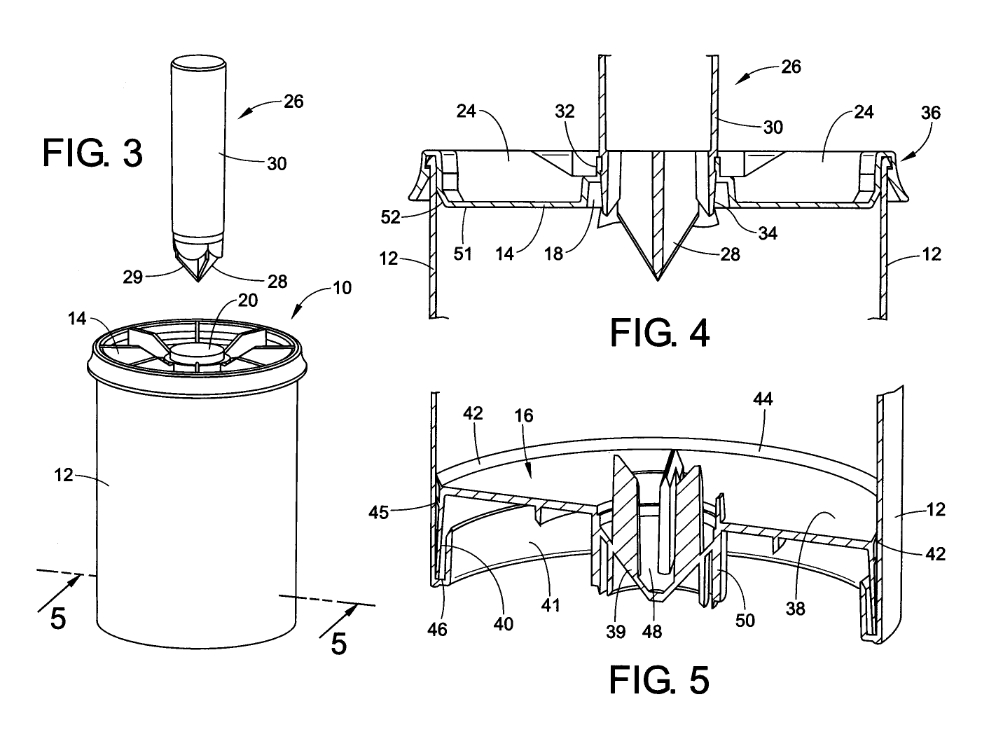

Referring now to FIG. 3, a system for storing and pouring body filler includes container 10 and a removable pouring spout 26. The pouring spout, which is provided with a pointed or tapered first end 28 with which the seal 20 can be pierced. Pointed end 28 can include three walls 29 which are arranged in a substantially star shaped conformation and are arranged adjacent an opening on one end of a pipe 30.

Referring now to FIG. 4, the end 28 of pouring spout 26 is provided on a side of end 28 with an external annular recess in which an annular internal edge 32 of pouring opening 18 can be received. Pouring spout 26 is further provided with an outer wall 34 which is tapered toward the end of the spout. The pouring spout is inserted into the pouring opening 18 and snapped or otherwise secured into place. The spout can also be released again by exerting a force on the spout. The lid is provided with an elastic snap closure 36 along its peripheral edge to secure the lid to the upper end of the cylinder wall of the container 10.

Referring now to FIG. 5, the plug 16 includes a circular plate 38 which contacts the filler. A frusto-conical and cylindrical side wall 40 extends from a peripheral edge of plate 38. The side wall 40 tapers slightly towards the peripheral edge of plate 38. An outer diameter of plate 38 is slightly smaller than an inner diameter of cylindrical wall 12. Side wall 40 has an outer diameter at a bottom end thereof which is substantially equal to the inner diameter of the cylindrical side wall 12, such that the side wall contacts the side wall 12.

An annular, strip-like, scraping element 42 extends in a generally upward direction and radially outward from wall 38. Scraping element 42 has an annular scraping surface 44 oriented in a tapered manner toward the inner surface of cylindrical wall 12. Scraping element 42 tapers to a point towards its outer end. The outer end of scraping element has a diameter substantially equal to the inner diameter of wall 12 of the container.

Situated a short distance along side wall 40, and spaced apart from the scraping element 42 is a second scraping element 45. Element 45 which has substantially the same conformation as scraping element 42, also extends upward to contact wall 12, in the same manner as element 42.

An end portion of the container, opposite the first end has a wall 41 which is parallel to or slightly tapered in relation to inner portion of wall 12 and forms a groove or clamping edge 46 to accommodate a lower end of the wall 40 of the plug or disc 16, as shown in FIG. 5.

Plate 38 is provided with a central conical portion 39 in which a cavity 48 is formed. The cavity receives pointed end 28 of pouring spout 26 when the disc 16 reaches the lid as it is moved upwardly. The cone 39 is surrounded by a central cylindrical wall 50 which can be used by the user of the container to exert pressure on the plug when emptying the container.

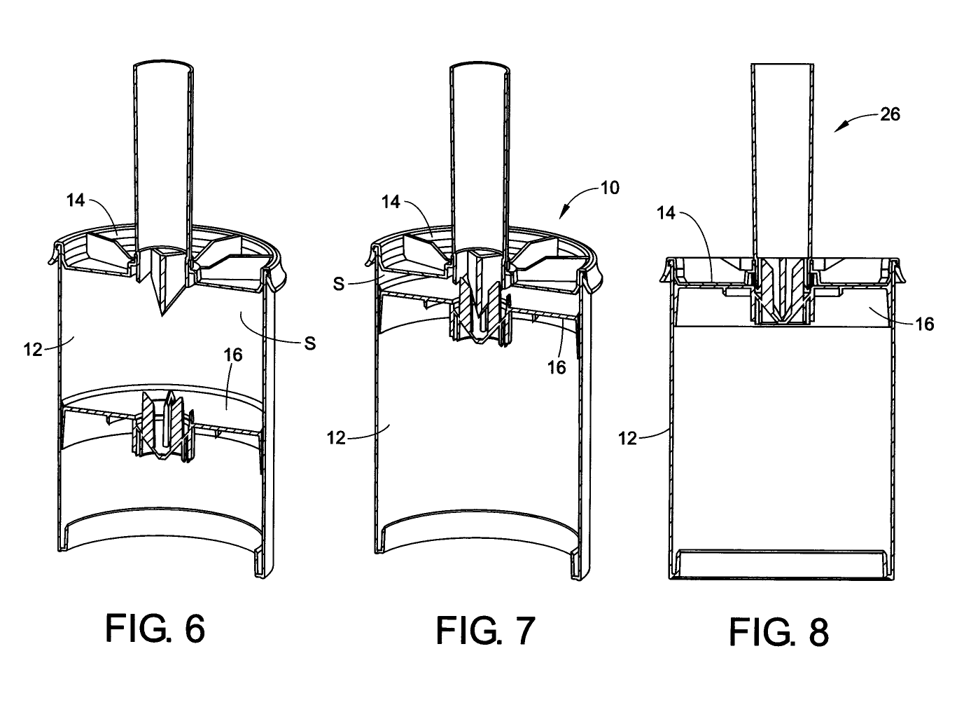

An underside 51 of the lid 14 has a peripheral edge with a chamfered surface 52 corresponding to scraping surface 44 of scraper 42. Disc 16 is pushed against the underside of the lid such that the surfaces fully contact each other, whereby body filler is pressed between them in space S, formed between the disc and lid, as shown in FIGS. 6-8. Only about 1 percent, or less of the body filler remains in the container after emptying.

The container 10 is used to store and dispense body fillers, such as those which include plastic microspheres. The plastic microspheres can consist of a polymeric shell encapsulating a blowing agent. The polymeric shell can be a copolymer of vinylidene chloride and acrylonitrile. The blowing agent can be isobutene.

An advantage of plastic microspheres is that they are easier to spray during a repair cycle and can be sanded to a finer finish as compared to glass microspheres. Also, plastic can be smaller in plastic microspheres than for glass microspheres and the adhesion between polyester resin and plastic microspheres is excellent. Thus, the porosity of a body filler containing plastic microspheres can be much smaller than for a filler with glass microspheres, and water does not penetrate plastic microspheres. Body fillers containing plastic microspheres have a lower surface hardness than conventional fillers using glass microspheres resulting in good adhesion and virtually no after sinking or shrinkage. Pinholes are virtually eliminated in the final finish application using plastic microspheres as compared to glass microspheres due to the much smaller particle size.

During the manufacturing process, plastic microspheres can handle increased stress in the mixing process as compared to glass microspheres and will not break like glass microspheres. In contrast, glass microspheres when put under increased stress in the manufacturing process tend to break up and absorb resin over an extended period of time causing the finished body filler to increase in viscosity, rendering a product which is basically unspreadable or unusable.

A further advantage of plastic microspheres is that transportation costs of plastic microspheres are much lower than those associated with glass microspheres. Plastic microspheres can be shipped from the manufacturer to a processing plant in an unexpanded form and then expanded at a 40:1 ratio on site. That is, one shipping container of unexpanded plastic microspheres corresponds to 40 shipping containers of glass microspheres.

Plastic microspheres also eliminate the need for the addition of a C₈ dicarboxylic functional unsaturated anhydride or acid, for example, as disclosed in U.S. Pat. No. 5,456,947. C₈ dicarboxylic functional unsaturated anhydride or acid is added to help increase surface adhesion of fillers to various substrates by etching the glass microspheres.

When formulating with plastic microspheres the use of C₈ dicarboxylic functional unsaturated anhydride or acid is not needed because the adhesion between polyester resin, plastic microspheres and substrate is excellent. The addition of C₈ dicarboxylic functional unsaturated anhydride or acid to body fillers, however, can have a detrimental effect to the top coat finishing of the repair process by causing the top coat finish to cure in an inefficient manner causing ringing, die back or shrinkage to the final finish.

The amount of body filler that the container holds at any one time is about equivalent to the volume defined by the containment space S. The volume of the containment space is variable by at least one moving wall defining the containment space. More specifically, disc 16 determines the volume by its position relative to the cylindrical wall 12 and lid 14.

The exemplary container is adapted to maximize an egress of the filler contents contained therein and, more specifically, an egress of generally viscous contents. In one embodiment, the body filler has a viscosity similar to a soft solid, when expelled from the container. The body filler can have a viscosity of at least 50 or at least 500 mPa s (millipascal-second) at 25° C. In one embodiment, the viscosity is at least 1000 or at least 10,000 mPa s and can be greater than 50,000 mPa s in the case of a putty, such as at least 100,000 mPa s and can be up to 300,000 or 500,000 mPa s. In one embodiment, the container is constructed to hold such a putty and to expel it, with no significant (or no) leakage from the container around the plug.

One aspect of the disclosure is a body filler which sets to a solid material that can be sanded. The body exemplary filler includes an organic resin component in which hollow microspheres are dispersed. The filler can also include one or more of a reinforcing component, a thickening agent, a dispersion aid, a colorant, and a solvent. The body filler is not limited to these component, other ingredients may also be present.

The resin component can include a polyester resin, such as an unsaturated polyester resin. Suitable polyester resins are cross-linkable polyester compounds obtained by the condensation of unsaturated polybasic acids or anhydrides with polyhydroxy compounds. The polymeric chain may optionally contain varying amounts of other saturated or aromatic dibasic acids and anhydrides which are not subject to cross-linking in order to reduce the degree of crosslinking of the hardened product.

Other resins may also be present in combination with or in place of the polyester resin, such as one or more acrylic resins.

The resin (exclusive of reactive monomer) may be present in the filler at a concentration of at least 10 wt. % and in one embodiment, is present at up to 50 wt. %. As an example, the resin is present at a concentration of at least 20 wt. %. The resin may be present at less than 30 wt. %.

An example of a suitable polyester resin an unsaturated polyester resin mixed with styrene and is supplied sold under the tradename VICAST™ by Reichhold Chemical, Inc. Other polyester resins are available from Bayer under the tradename ROSKYDAL™. Such polyester resins may contain about 30 wt. % styrene. Exemplary acrylic acid resins include those sold under the tradename ACRONAL™ by BASF.

The resin component can also include a reactive unsaturated monomer or polymer which is copolymerizable with the resin to form a hardened product. Exemplary reactive monomers are liquids and may include at least one C═CH₂ group, such as substituted and unsubstituted vinyl benzenes, e.g., styrene.

The styrene and/or other reactive monomer(s) may be present in sufficient amount to form a hardened product, e.g., may be present in the filler at a weight ratio of resin:monomer of from about 1:1 to about 20:1. For example, the reactive monomer, e.g., styrene, may be present in the body filler at a concentration of at least 0.5 wt. % and in one embodiment, is present at up to 60 wt. % (this includes any reactive monomer which has already been mixed with the commercial resin). As an example, the reactive monomer is present at a concentration of at least 10 wt. %. The reactive monomer may be present at less than 30 wt. %, e.g., about 25 wt. % or less.

The resin component can further include a polymerization agent, which accelerates/initiates the copolymerization reaction between the resin and reactive monomer/polymer. Exemplary polymerization agents for polyester resins include free radical catalysts, such as organic peroxides and hydroperoxides, e.g., benzoyl peroxide, cumyl peroxide, methyl ethyl ketone peroxide, t-butyl hydroperoxide, cumene hydroperoxide, and the like, and amine cure promoters, such as N,N-dimethyl-para-toluidine (DMPT), N,N-dimethylaniline (DMA) and N,N-dimethylacrylamide (DMAA). Other acrylates, such as trimethylolpropane triacrylate (TMPTA) can be included to aid in curing. The polymerization agent(s) can be present in the body filler at a total concentration of at least 0.01 wt. % and can be present at up to about 5 wt %, e.g., up to about 3 wt. %. Air release additives and/or oxygen scavengers may also be present to improve ambient cure of the resin and avoid air bubbles in the hardened product.

The microspheres can be formed from plastic or an inorganic material, such as glass. The exemplary microspheres are formed from a plastic material that is lighter in weight than its conventional glass counterpart, and thus the microspheres are easier to expel from the container through the pour spout. The body filler can also be less dense than a body filler formed with glass microspheres.

The plastic microspheres can each include a polymeric shell encapsulating (at least during their formation) a blowing agent. The polymeric shell can be formed of a thermoplastic material, such as a copolymer of vinylidene chloride and acrylonitrile (poly(acrylonitrile-co-vinyl chloride). The blowing agent can be a hydrocarbon which is gaseous, at least when the microspheres are heated, such as isobutene.

Suitable plastic microspheres are available under the tradename EXPANCEL™ from Akzo Nobel.

The plastic microspheres may be present in the body filler at a concentration of at least about 1 wt. % and can be up to about 10 wt. %, e.g., up to about 3 wt %. As will be appreciated, the expanded microspheres account for a much larger percentage of the body filler when expressed in terms of volume. In the case of glass microspheres, a somewhat higher amount can be used.

An advantage of plastic microspheres is that they are easier to spray during a repair cycle and can be sanded to a finer finish as compared to glass microspheres. Also, plastic microspheres do not wear out abrasive material such as sandpaper as quickly as glass microspheres. Further, plastic microspheres are virtually water resistant and do not absorb moisture. Additionally, the particle size of plastic microspheres can be smaller than for glass. The adhesion between a polyester resin and plastic microspheres can be excellent. The porosity of a body filler (e.g., putty, flow putty or spray filler) containing plastic microspheres can be much lower than for glass microspheres. Body fillers containing plastic microspheres can have a lower surface hardness than conventional fillers using glass microspheres resulting in good adhesion and virtually no after sinking or shrinkage. Pinholes are virtually eliminated in the final finish application using plastic microspheres as compared to glass microspheres due to the much smaller particle size.

During the manufacturing process, plastic microspheres can handle increased stress in the mixing process as compared to glass microspheres and do not break like glass microspheres. In contrast, glass microspheres, when put under increased stress in the manufacturing process, tend to break up and absorb resin over an extended period of time causing the finished body filler to increase in viscosity, resulting in a product which is very difficult to spread.

A further advantage of plastic microspheres is that transportation costs of plastic microspheres can be much lower than for glass microspheres since the microspheres can be shipped in an unexpanded form and expanded on site (by a volume ratio of about 40:1).

Plastic microspheres also eliminate the need for the addition of an etchant, such as a C₈ dicarboxylic functional unsaturated anhydrides or acids. These are conventionally added to fillers to etch the glass microspheres in order to improve adhesion to the resin and substrate (See, for example, U.S. Pat. No. 5,456,947). Addition of C₈ dicarboxylic functional unsaturated anhydride or acid to body fillers, however, can have a detrimental effect on the top coat finishing of a repair process. The top coat finish cures in an inefficient manner causing ringing, die back or shrinkage to the final finish. In one embodiment, the body filler is free of such etchants. The exemplary body filler containing plastic microspheres is free of such C₈ dicarboxylic functional unsaturated anhydride/acid etchants.

The reinforcing component can include one or more inorganic particulate filler materials. Exemplary inorganic fillers which can be utilized include amorphous fumed silica, silica, silica flour, talc (predominantly calcium magnesium carbonate), magnesium silicate (hydrate), calcium carbonate, clay, shell flour, wood flour, alumina, barium sulfate, calcined clays, China clays, magnesium oxide, mica powder, and the like. An exemplary inorganic filler material is a combination of one or more forms of talc with barium sulfate and/or calcium carbonate. Exemplary talcs are available, for example under the tradename TALCOR™ from Canada Talc Ltd., Ontario, which in addition to talc, includes about 15-40% by weight termolite (nonasbestiform), and about 0.1-1% by weight crystalline silica and quartz; and under the tradenames NICRON™ and CIMPACT™, available from Luzenac Corporation.

The inorganic filler(s) can be present in the body filler at a total concentration of at least 10 M. %, e.g., at least 15% or at least 20 wt. % and can be up to about 65 wt. %, e.g., up to about 55 wt %. A weight ratio of resin:inorganic filler may be, for example, from about 2:1 to about 1:3.

Suitable thickening agents include clays, such as bentonite clays and organoclays, which may be included in the total weight of inorganic filler, as well as organic thickening agents, such as trihydroxystearin. Organoclay Bentone is one commercially available inorganic mineral partly modified with organic cations, which is available under the tradename THIXOGEL from United Catalyst Corporation. The thickening agent(s) may be present in the body filler at a total concentration of about 0-5 wt. %, e.g., at least 0.1 wt. %, such as about 0.4-3 wt. %.

Suitable dispersion aids include calcium driers and leveling agents. Calcium driers contain calcium as a major ingredient. Exemplary leveling agents include polysiloxanes, such as phenylmethyl polysiloxane. The dispersion aid may be present in the body filler at a total concentration of from 0-5 wt. %, e.g., at least 0.1 wt. %, and in one embodiment, up to 3 wt. %.

Exemplary colorants include pigments, such as titanium dioxide and various titanates, chromates, iron oxide pigments, and the like. The colorant(s) (excluding any titanium dioxide) may be present in the body filler at a total concentration of about 0-10 wt. %, e.g., at least 0.1 wt. %, such as about 0.4-5 wt. %.

Additional solvents for the resin, other than the reactive monomers/polymers, may also be present in the body filler, such as methyl esters of the aliphatic dicarboxylic acids, alkyl acetates, and the like. The solvent may be present in a concentration of 0-10%.

Other additives which may be included in the body filler include preservatives, air release additives, and the like. Any preservative can be used, such azoles, e.g., propiconazole, tebuconazole, and permethrin, which are available diluted with a hydrocarbon solvent under the tradename PREMIX B, and phatidylethanolamine. Such additional additives can be present in the body filler at a concentration of 0-3 wt. %, e.g., at least about 0.01%.

To form the body filler, the plastic microspheres are mixed with at least a polyester resin to form the body filler. This may be performed before the body filler is placed in the container. The relative amounts of plastic microspheres to resin component can be selected to result in a putty having a density of from about 0.40 kg/l to about 1.10 kg/l. In one embodiment, the density of the body filler (e.g., a putty) is approximately 1.0 kg/l.

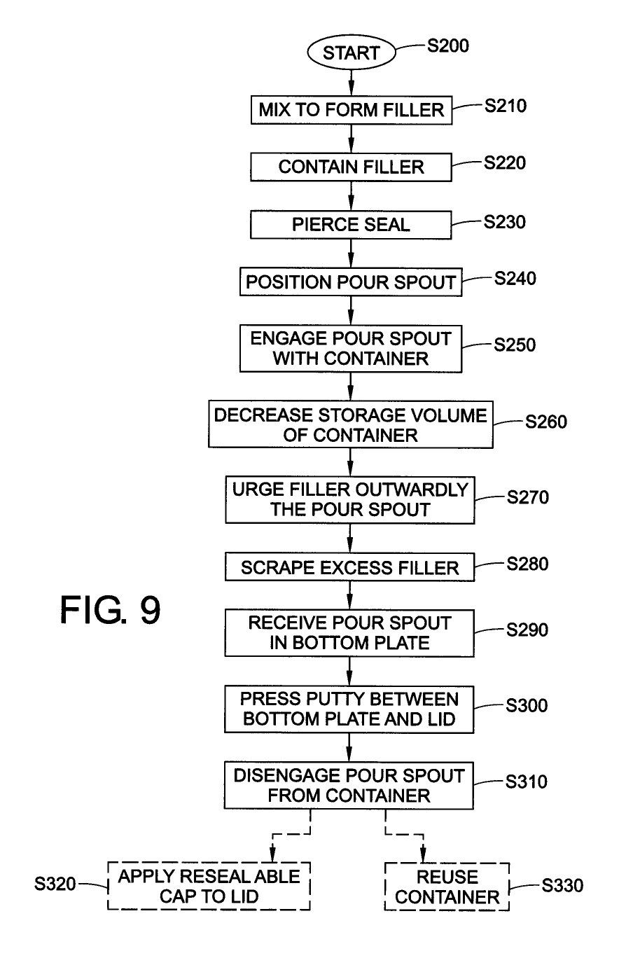

The soft-solid viscosity body filler or putty can be urged outwardly from the container 10 by the following method, which is illustrated in the flow-chart of FIG. 9. The method begins at step S200. At least plastic microspheres and polyester resin component are mixed to form a filler at step S210. Additional fillers, colorants, solvents, thickening agents, and the like, can be included in the mixture in various combinations, such as, for example, talc, pigments, and any combination of ingredients as described above. Furthermore, the filler formulation can be formed from volumes of ingredients aimed to achieve a putty having a predetermined viscosity. In the present disclosure, for example, the ingredients are mixed to form a putty having a viscosity similar to a soft solid. In an exemplary embodiment, the ingredients are mixed for at least 15 minutes in the mixing action of step S210.

In step S220, the putty or other body filler is contained in the container disclosed herein to maintain a predetermined density. Initially, a central pouring opening 18 of the container is sealed by means of the aluminum foil seal 20 or a similarly malleable film-like strip. The malleable film strip or seal is pierced, broken, deformed or removed in step S230 to access the filler contained in the container. Pointed end 28 of a piercing mechanism (spout 26) tears the strip.

In step S240, pour spout 26 is positioned relative to the central pouring opening or aperture 18 to assist in controlling a flow path of the body filler material. The pouring spout functions as the piercing mechanism. In step S250, the pour spout is positioned to engage the plug 16 of the container. A tapering outer wall 34 of the pour spout is captured within a recess formed at an annular internal edge 32. The tapered wall can snap-fit into an engagement within the recess. This engagement is not permanent; however, a forceful pull on the spout will release the engagement to remove the spout when desired.

In the next step S260, the user or associated mechanism supporting the container initiates pouring of the filler putty from the container which decreases the volume of the container storing the putty between the plug and the lid. Particularly here the body filler is a putty which has a high viscosity, an additional force may be employed to encourage a flow of the putty outwardly through the opening of the pour spout. The plug 16 is moveable, and it is moved upwardly toward the lid and pour spout to assist in pouring/expelling the putty therefrom. The plug 16 is moveable in both directions (up and down) along a longitudinal axis of the container. The volume of the containment space S is decreased by moving the plug. The plug moves the putty or other body filler toward the pour spout.

In step S270, a manual force is applied to the plug, which urges the residual putty out of the pour spout. Movement of the plug induces scraping elements 42, 44 to scrape an inner surface of the cylindrical wall 12. Scraping removes any excess putty remaining adhered to the wall so that there is minimal residue or unused body filler product remaining in the container.

Referring to step S290, as the plug approaches an opposite surface of the lid, upper side of a cavity 48 receives the pointed end of the pouring spout. Step S300 includes pushing the plug against the lid to press the filler or putty from all the spaces formed between adjacent inner surfaces. Clamping edge 46 at an underside of the cylindrical sidewall clamps an outer peripheral edge of the disc between the clamping edge and the cylindrical sidewall.

Note that the entire contents of the putty do not need to be emptied from the container. Referring to step S310, the pouring spout is disengaged from the lid. After disengaging the spout, the resealable cap 22 is installed over the central pouring spout in step S320 to close the container. The remaining putty contained therein may be used at a later time. In step S320, if all the putty has been removed from the container, the container itself may be reused with additional filler material.

### EXAMPLES

A first body filler material in the form of a putty is formed by combining 1-2 wt. % thermoplastic microspheres, 44-46 wt % of a mixture of polyester resin in styrene, an additional 3 wt. % of styrene, less than 3% of polymerization agents, about 48-50 wt % inorganic fillers (a mixture of titanium dioxide, talc, magnesium silicate, silica, and calcium carbonate), no pigments (other than titanium dioxide), other additives being present at less than 2 wt. %. The body filler material can be dispensed from the container.

A second body filler material is formed by combining 1-2 wt. % thermoplastic microspheres, from 44-46% wt % of a mixture of polyester resin in styrene, an additional 1-3 wt. % of styrene, about 46 wt % inorganic fillers (a mixture of talc, magnesium silicate, silica, and calcium carbonate and less than 1 wt. % of titanium dioxide), about 4% pigments (other than titanium dioxide), about 3 wt. % of polymerization agents including DMA, DMAA, and trimethylopropane, about 0.1 wt. % of an oxygen scavenger, other additives being present at less than 2 wt. %. The body filler material can be dispensed from the container.

A third body filler material is formed by combining 2-3 wt. % thermoplastic microspheres, from 56-59 wt % of a mixture of polyester resin in styrene, an additional 6 wt. % of styrene, about 32 wt % inorganic fillers (a mixture of talc, calcium carbonate and about 3 wt. % of titanium dioxide), less than 1% pigments (other than titanium dioxide), 0.2-3 wt. % of polymerization agents, 0.1-1% clay, about 1.5% 3,4,5,6-tetrahydrophthalic anhydride, other additives being present at less than 2 wt. %. The body filler material can be dispensed from the container.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claim or the equivalents thereof.

1. A combination of a body filler and a container for dispensing the body filler, comprising:
a body filler having a density adapted for containment in the container; the filler including at least plastic microspheres and a polyester resin; and,
a container for storing and dispensing said body filler, said container comprising a closable opening, a cylindrical wall, a closure for selective closing said opening, and a plug axially movable within said cylindrical wall of said container, wherein said container plug is configured for pushing against a volume of the body filler to urge the filler through said opening of said container.

2. The combination of claim 1, wherein said at least a side of the plug directed toward the closure has an outer diameter which in a radial direction is smaller than an inner diameter of the container, wherein the side of the plug which is directed toward the closure is provided along the peripheral edge with a first scraping element extending laterally from the peripheral edge of the plug to the wall of the container.

3. The combination of claim 2, wherein the first scraping element is oriented obliquely to the closure.

4. The combination of claim 3, wherein the first scraping element is strip-like and has a sharp edge on its outer end.

5. The combination of claim 3, wherein the side of the closure directed toward the plug is provided with a recess in which the first scraping element can be received such that surfaces of the plug and the closure can rest at least substantially fully against each other.

6. The combination of claim 5, wherein the plug is provided with a second scraping element extending from the peripheral edge of the plug at a distance from the first scraping element.

7. The combination of claim 6, wherein the second scraping element has substantially the same form as the first scraping element and extends in the same direction.

8. The combination of claim 7, wherein the peripheral edge of the plug is substantially frusto-conical, wherein an outer diameter of the plug on the side remote from the closure is substantially equal to the inner diameter of the container.

9. The combination of claim 8, wherein the plug is provided with external engaging means in order to move the plug in the container.

10. The combination of claim 9, wherein said closable opening is provided in the closure.

11. The combination of claim 10, wherein the closable opening is sealed with a tearable foil.

12. The combination of claim 1, wherein the plastic microspheres include: a blowing agent; and, a polymeric shell.

13. The combination of claim 12, wherein the blowing agent includes isobutene.

14. The combination of claim 12, wherein the polymeric shell includes a copolymer of vinylidene chloride and acrylonitrile.

15. The combination of claim 1, wherein the body filler does not include an anhydride or an acid agent for etching or surface adhesion.

16. The combination of claim 1, wherein the body filler further includes inorganic fillers.

17. The combination of claim 1, wherein the body filler has a viscosity of at least 500 mPa s at 25° C.

18. A combination of a body filler and a container for storing and pouring the body filler, comprising:
a filler having a viscosity that requires an urging mechanism to assist flow thereof;
at least a thermoplastic microsphere included in the filler; and,
a container including a movable plate that reduces a volume of a containment space defined by the container, wherein movement of the plate dispenses the filler through an opening of the container.

19. The combination of claim 18, further comprising an outlet pipe through which said filler is discharged from the container, wherein said outlet pipe is provided with mounting means with which the outlet pipe can be mounted in said opening of the container.

20. The combination of claim 19, wherein the mounting means comprises releasable snap connecting means.

21. The combination of claim 19, wherein the outlet pipe is provided with a pointed outer end with which a seal of the opening of the container can be pierced.

22. The combination of claim 18, wherein the filler further includes a polyester resin.

23. The combination of claim 18, wherein the thermoplastic microsphere makes up no greater than 3% by volume of the filler.

24. The combination of claim 18, wherein the thermoplastic microsphere makes up a volume of from no greater than 2.5% of the filler, wherein the polyester resin makes up a volume of at least 35% of the filler.

25. The combination of claim 18, wherein the filler does not include an additive for etching.

26. A method of dispensing a body filler, comprising:
mixing at least a thermoplastic microsphere and a polyester resin to form a filler having a viscosity similar to a soft solid;
containing the filler in a container adapted to maintain a density of the filler and to dispense said filler;
selectively urging the filler through an opening formed in the container by movement of a plate inside the container toward the opening;
wherein said filler is contained in said container between said opening and said plate.

27. The method of claim 26, further including:
piercing a seal in said container opening with a pouring mechanism;
securing an engagement of the pouring mechanism to the container;
moving the plate toward the pouring mechanism; and,
pouring the filler from the pouring mechanism;
wherein moving the plate toward the pouring mechanism decreases an available volume in a containment space within the container containing the filler which urges said filler through said opening.

28. The method of claim 27, further including mixing into the filler the at least a thermoplastic microsphere at a concentration of no greater than 2.5 wt % of the filler; and mixing the polyester resin at a concentration of at least 35 wt. % of the filler.
